(19) United States
(12) Patent Application Publication
(10) Pub. No.: US 2004/0020731 A1
(43) Pub. Date: Feb. 5, 2004

(54) Shock damping device for a vehicle attachment

(76) Inventor: Hans G. Hillreiner, Hirtlbach (DE)

Correspondence Address: Gunnar G. Leinberg, Esq., NIXON PEABODY LLP, Clinton Square, P.O. Box 31051, Rochester, NY, 14603-1051, US

(21) Appl. No.: 10/212,662

(22) Filed: Aug. 1, 2002

(51) Int. Cl. F16F 9/00

(52) U.S. Cl. 188/322.19

(57) ABSTRACT

The invention relates to a shock damping device for bicycles for damping mechanical impacts especially with respect to the bicycle handle bar or the bicycle seat, whereby a twist stop portion (16) includes sliding blocks, for example in the form of balls (28) so that an axial movement of a first connecting portion (12) in relation to a second connecting portion (14) is enabled, but essentially no twisting motion between the first and second connecting portions.

### FIELD OF THE INVENTION

The invention relates to shock damping devices, for example for bicycles for the dampened supporting of seats, especially bicycle seats, handle bars, or the like.

### BACKGROUND

Saddle posts have been recently developed which are dampened in order to isolate mechanical influences as much as possible from the rider.

DE 8624829.4 U1, for example, discloses a seat shock absorber for a bicycle in which a first connecting portion shaped as a cylindrical hollow body, includes a spring arrangement which is clamped between a support and a second connecting portion. The second connecting portion is provided for attachment of the saddle. The first connecting portion can be axially moved relative to the second connecting portion cushioned by the spring arrangement. In order to avoid twisting of the first connecting portion relative to the second connecting portion and thereby a twisting of the bicycle seat relative to the bicycle frame, the first connecting portion has longitudinal slots as guide slots, while disk shaped guide elements which are guided in the slots are associated with the second connecting portion. Although a twisting of the bicycle seat relative to the bicycle frame can be prevented, the mechanical forces which act on the guide slots or the guide elements are so large that the appropriate function of this type of twist stop can only be guaranteed for a comparatively short time. As long as the guide slots or the guide elements are subject to a certain degree of wear, not only the function of the twist stop is negatively affected, but the whole damping behavior.

DE 9200156.4 U1 also discloses a spring-supported saddle post for bicycles, in which a twisting is prevented by way of a lever linkage, by guide grooves in connection with a guide fin, by way of a guide pin which extends into a guide tube, or the like. Here again, mechanical stresses occur which sooner or later lead to strong signs of wear.

EP 0734944 A1 also discloses a shock damping device for bicycles which although it is significantly improved with respect to its damping properties and safety still can be further improved with respect to the twist stop and its wear.

### SUMMARY OF THE INVENTION

The present invention provides a shock damping device especially for a bicycle seat, a bicycle handle bar or the like wherein no signs of wear affect the service life of the shock damping device itself and the shock damping function.

The advantages achievable according to the present invention are based on a shock damping device or saddle post which has a first connecting portion for mounting of the shock damping device or saddle post to a vehicle or bicycle frame and, furthermore, a second connecting portion for connecting the shock damping device or saddle post with the seat, especially the bicycle seat. The device in accordance with the invention further includes a spring or shock damping portion, for instance in the form of a pneumatic or hydraulic shock absorber, at least one guide track or several guide tracks, flutes, slots, grooves, or the like and a twist stop portion for counteracting a twisting of the seat relative to the vehicle or bicycle frame, whereby the connecting portions mutually overlap and the twist stop portion is positioned in the overlapping region. In accordance with the invention the twist stop portion includes guides, for example, in the form of sliding blocks, whereby the sliding blocks can be constructed as balls, rollers or the like, which permit an axial movement of the first portion relative to the second portion, but essentially no rotational movement, whereby they engage the guide tracks, grooves or flutes, or the like. The sliding block or blocks which is/are fixed in circumferential direction of the connecting portions and which engage(s) for example, a guide track, groove or flute, for example, in the second connecting portion, can be positioned to be be freely rotatable relative to the guide member and within their bearing housing in the twist stop portion, so that upon reciprocating movements for the cushioning of mechanical shocks the guiding can take place with as little friction as possible. This means, for example, that the second connecting portion can be coaxially moveable in the first connecting portion, whereby a rotation movement of the first connecting portion relative to the second connecting portion is prevented by the co-operation of the guide members with the sliding blocks, whereby, however the free coaxial cushioning movement or damping movement is permitted, for which the guide members or guides are aligned parallel to the direction of the cushioning or damping movement.

Of course, comparable advantages can also be achieved when the shock-damping device in accordance with the invention is used to achieve a shock damping between a front wheel fork and a handle bar of a vehicle and especially a bicycle.

The sliding blocks, balls, rollers, or the like which are positioned in the twist stop portion, can be maintained stationary either with respect to the first or the second connecting portion. The respectively other connecting portion can then be moveable axially or coaxially relative to that connecting portion in relation to which the sliding blocks are fastened, while it is secured against twisting by the construction of the guide tracks.

Although the slide blocks or balls, or the like can be positioned along the circumference at different heights to one another,in order to act equally in axial direction while being more stable with respect to transverse forces, it is to be preferred for reasons of manufacturing technology that the balls or sliding blocks are positioned in one plane parallel to the cross-sectional plane of the first or the second connecting portion.

In order to achieve a stabilization especially also against transverse forces, it is especially advantageous, when in the axially direction of movement, more than one ball, roller or the like, in any case a sliding block is positioned, whereby those several sliding blocks positioned, for example one behind the other, take on the guiding of the first connecting portion with respect to the second or vice-versa. Such an arrangement should be provided at least once in order to achieve the desired stabilization with respect to transverse forces. Of course, a shock damping device in accordance with the invention is especially stabilized when at least at three locations, distributed over the circumference of the first or the second connecting portion within the twist stop portion, respectively at least two sliding blocks, balls, rollers or the like are positioned one behind the other, whereby the supporting of the sliding blocks or rollers is carried out in a manner conventional in ball-bearings. For example, the balls can be supported as friction free as possible by way of graphite, oil or similar lubricants. Preferably, the sliding blocks, balls or the like are positioned in axial direction of movement in such a way that they can follow along for at least a portion in the axial direction of movement. The axial friction can additionally be reduced in this manner, while the guiding properties can be additionally improved. The service life of the device in accordance with the invention can hereby be significantly increased.

An especially advantageous embodiment results when the sliding blocks, balls, rollers, or the like are received in circulatory bearing tracks. Upon each axial damping movement several balls, which preferably essentially fill the circulatory bearing tracks, can move along so that on the one hand a guiding as large as possible is achieved and on the other hand very small signs of wear occur on the sliding blocks themselves or the balls or the like, which again improves the service life of the device in accordance with the invention. A corresponding device in accordance with the invention with circulatory bearing tracks or with circulatory ball bearings is also advantageous with respect to transverse forces.

Especially advantageous and practical is a twist stop portion which includes three or four circulatory ball bearings, which are angularly evenly distributed over the circumference of the associated connecting portion.

In order to optimize the size of the twist stop portion, it can be, for example, of oval shape in cross-section relative to the axial damping movement of the first connecting portion relative to the second connecting portion, so that in the case of several sliding blocks or circulatory ball bearings they are opposite to one another or pair-wise opposite to one another.

### BRIEF DESCRIPTION OF THE DRAWINGS

The invention will now be further described by way of example only and with reference to the attached drawings, wherein

FIG. 1a shows a first embodiment according to the invention in cross-sectional view;

FIG. 1b shows an axial longitudinal section of the first embodiment shown in FIG. 1a taken along line A-A;

FIG. 2a illustrates a cross-section of a simplified embodiment according to the invention;

FIG. 2b is an axial longitudinal section through the embodiment shown in FIG. 2, taken along the line A-A;

FIG. 3a is a cross-section through an advantageous third embodiment in accordance with the invention, comparable to the illustrations of FIG. 1a and 2a;

FIG. 3b is an axial longitudinal section through the embodiment of FIG. 3 taken along line A-A;

FIG. 4a is a cross-section through a preferred embodiment according to the invention; and

FIG. 4b is an axial longitudinal section through the preferred embodiment of FIG. 4a taken along the line A-A.

### DETAILED DESCRIPTION

The embodiments of the devices according to the invention as shown can principally be used anywhere where mechanical impacts or shocks are to be kept away from the rider of two-wheeled vehicles, which means bicycles such as racing bikes, mountain bikes, or the like. This means the shock damping device in accordance with the invention can serve, for example, as saddle post, between the handle bar and the frame, within a frame of a bicycle or a cycle, in the region of the front extension of the handle bar, in the region of the front fork or in the region of the front fork shaft, in order to fulfill its purpose.

Parts which are identical or at least of the same function are referred to by the same reference numeral throughout the Figures.

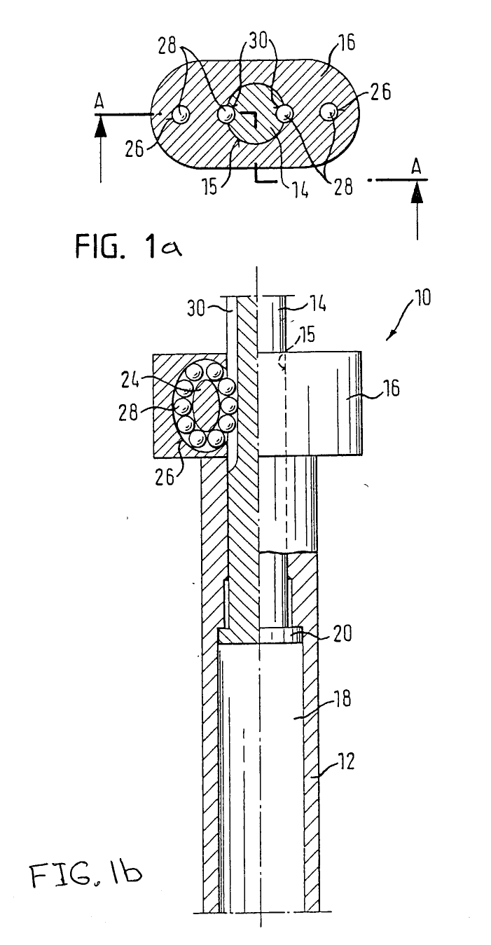

A shock-damping device 10 is illustrated in FIG. 1a in a cross-sectional illustration through a twist stop portion 16 and in FIG. 1b in longitudinal section according to section A-A in FIG. 1a.

FIG. 1a correspondingly illustrates the twist stop portion 16, which is at least approximately oval in construction. A second connecting portion 14 at the upper end of which, for example, a saddle or handle bar connects, extends through the twist stop portion 16. The second connecting portion 14 includes guide tracks 30 in the form of guide grooves or guide flutes which are engaged by the balls 28 in direction from the body of the twist stop portion 16. The balls 28 are supported in the twist stop portion 16 within circulatory bearings 26. Upon an axial shock, the second connecting portion 14 can be guided through the twist stop portion 16 or its passage 15 and can move therethrough secured against rotation by the balls 28. The axial longitudinal section of the damping device 10 according to FIG. 1b shows the location of the circulatory ball bearing 24 within the twist stop portion 16. The balls 28 are freely rotatable within the circulatory bearing space 26 and supported in a freely moveable manner. Upon each shock acting on the lower, first connecting portion 12 or on the upper, second connecting portion 14, the balls 28 can, on the one hand, axially move and on the other hand, freely rotate about their own center point. In this very advantageous embodiment also in accordance with the invention, only very small friction losses occur and even very fast and short impacts can be cushioned unimpaired by the support or twist stop 16. This is also possible for a very long time, which was, for example, not the case for conventional guides, since they are relatively easily and quickly worn or worn-out.

Even when individual balls are used which are distributed about the circumference of the first or the second connecting portion, the advantages achievable according to the most preferred embodiments can by far not be achieved, although already large advantages are achieved over the prior art. In the case of individual balls, which can only rotate about their own centre, but cannot be weighed in axial direction of impact, points of damage appear already after short time on the balls upon larger impact, which damage can already lead after a comparatively short time to failure of the whole shock absorbing device. This is not the case in the situation predestined according to the embodiments of the present invention.

The upper connecting portion 14 which links to the handlebar or the seat extends by way of a shoulder portion 20 into the shock absorbing space 18 of the lower or second connecting portion 12. The space 18 includes, for example, a mechanical spring, a pneumatic or hydraulic spring, or the like which can dampen and mitigate the energy of the shock.

In the illustrated embodiment it is principally also possible to construct the connecting portion 12, for example, so that it carries a seat or a handlebar, in order to construct the connecting portion 14 so that it is connected with the bicycle frame in the widest sense.

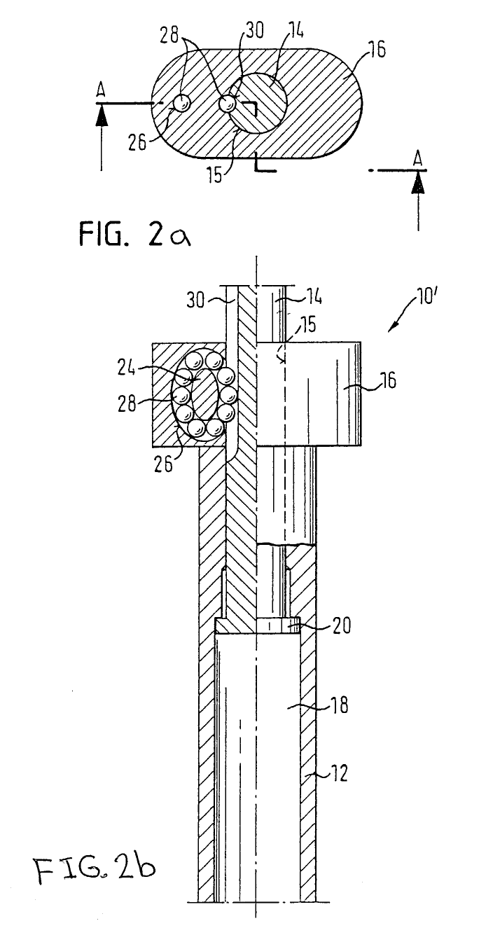

The following embodiments according to the FIGS. 2a, 2b, 3a, 3b, and 4a, 4b are distinguished from the embodiment according to FIG. 1 essentially only by the number of the ball bearings or circulatory ball bearings which are respectively used.

Only a single circulatory ball bearing is used according to FIG. 2a for forming a twist lock. This will lead to friction at the adjoining regions between the connecting portion 14 and the body of the twist lock 16, opposite the circulatory ball bearing, which can cause wear. Furthermore, at the edges of the balls, forces can be generated which lead to wear of the balls of the ball bearing. This correspondingly also applies to the embodiment according to FIG. 1a in which transverse forces can also occur which can act not on the balls but on peripheral edge regions of the connecting portion and can lead to signs of wear.

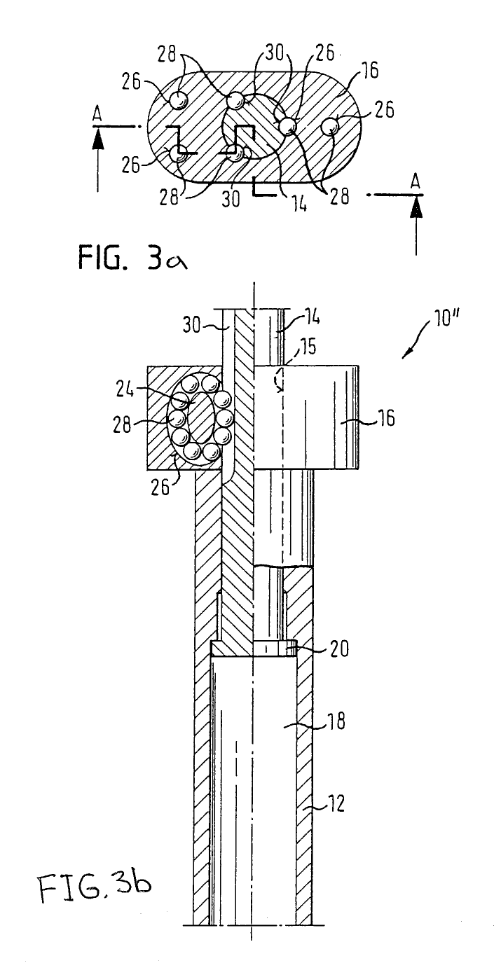

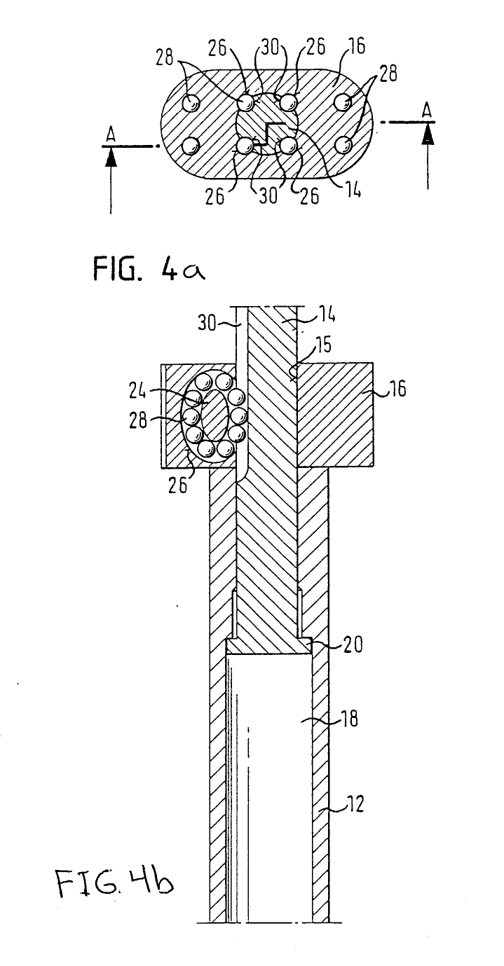

In contrast, several circulatory ball bearings are used in the embodiments according to FIGS. 3a and 4a, namely 3 in the one of FIG. 3a and 4 in the one of FIG. 4a. Possibly occurring transverse forces can here also be absorbed by the ball bearings and, therefore, those embodiments are to be preferred with respect to their durability and functional reliability.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefor, is not intended to limit the claimed processes to any order except as may be specified in the claims. Accordingly, the invention is limited only by the following claims and equivalents thereto.

What is claimed is:

1. A shock damping device for the dampened supporting of a vehicle attachment the device comprising:
a first connecting portion for fastening the shock damping device to a vehicle portion;
a second connecting portion for connecting the shock damping device to the vehicle attachment, the connecting portions overlapping one another in a region of overlap;
a spring or shock damping portion;
at least one guide track;
a twist stop portion positioned in the region of overlap for counteracting a twisting of the vehicle attachment with respect to a vehicle frame;
the twist stop portion including at least one sliding block for engaging one of the at least one guide tracks to permit axial movement but essentially no twisting movement of one of the first and second connecting portions relative to the other.

2. The shock damping device according to claim 1, wherein the vehicle is a bicycle, the vehicle portion is a bicycle portion, the guide tracks are at least one of grooves and flutes, the twist stop portion includes several sliding blocks, and the sliding blocks are at least one of balls and rollers.

3. The shock damping device according to claim 1, wherein the sliding blocks are maintained stationary in the twist stop portion relative to one of the first and second connecting portions.

4. The shock damping device according to claim 1, wherein the sliding blocks are provided in a plane parallel to a cross-sectional plane of the first or second connecting portion.

5. The shock damping device according to claim 1, wherein in at least one region of the twist stop portion more than one sliding block are positioned one behind the other in the axial direction of movement of the first connecting portion relative to the second connecting portion.

6. The shock damping device according to claim 5, wherein the sliding blocks are provided in at least three regions of the twist stop portion and the sliding blocks are selected from at least one of balls and rollers.

7. The shock damping device according to claim 1, wherein the sliding blocks are positioned in the axial direction of movement and can at least sectionally follow along in the axial direction of movement with at least one of the first and second connecting portions.

8. The shock damping device according to claim 1, wherein the sliding blocks are received in the axial direction of movement in a bearing space, whereby the bearing space has a larger extent in the axial direction of movement of the connecting portions than in the circumferential direction of the connecting portions.

9. The shock damping device according to claim 1, wherein the sliding blocks are positioned in at least one circulatory bearing space.

10. The shock damping device according to claim 1, wherein the twist lock portion includes at least one circulatory ball bearing for engaging one of the guide tracks.

11. The shock damping device according to claim 10, wherein the twist lock portion includes at least three circulatory ball bearings which are angularly distributed over the circumference of the associated connecting portion with respect to their engagement in the associated connecting portion.

12. The shock damping device according to claim 11, wherein the circulatory ball bearings are angularly evenly distributed over the circumference of the associated connecting portion.

13. A shock damping device for vehicles such as bicycles for the dampened supporting of a vehicle attachment, the device comprising:
a first connecting portion for fastening the shock damping device to a portion of the vehicle;
a second connecting portion for connecting the shock damping device with the vehicle attachment, the connecting portions overlapping one another in a region of overlap;
a spring or shock damping portion;
at least one guide track;
a twist stop portion positioned in the region of overlap for counteracting a twisting of the vehicle attachment with respect to a vehicle frame,
the twist stop portion including at least one sliding block for permitting mutual axial movement of the connecting portions, but essentially no twisting movement, whereby the at least one sliding block engages the at least one guide track and the at least one sliding block is positioned in the axial direction of movement and can at least sectionally follow along in the axial direction of movement with at least one of the first and the second connecting portions.

14. The shock damping device according to claim 13, wherein the vehicle portion is a bicycle portion, the guide tracks are grooves or flutes, the twist stop portion includes several sliding blocks, and the sliding blocks are selected from the group of balls, rollers or the like.

15. A shock damping device for vehicles such as bicycles for the dampened supporting of a vehicle attachment, the device comprising:
a first connecting portion for fastening the shock damping device to a portion of the vehicle;
a second connecting portion for connecting the shock damping device with the vehicle attachment, the connecting portions overlapping one another in a region of overlap;
a spring or shock damping portion;
at least one guide track;
a twist stop portion positioned in the region of overlap for counteracting a twisting of the vehicle attachment with respect to a vehicle frame,
the twist stop portion including at least one sliding block for permitting mutual axial movement of the connecting portions, but essentially no twisting movement, whereby the at least one sliding block engages the at least one guide track, wherein the twist lock portion includes at least one circulatory ball bearing for engaging one of the guide tracks.

16. The shock damping device according to claim 15, wherein the twist lock portion includes at least three circulatory ball bearings which are angularly distributed over the circumference of the associated connecting portion, especially with respect to their engagement in the associated connecting portion.

17. The shock damping device according to claim 11, wherein the circulatory ball bearings are angularly evenly distributed over the circumference of the associated connecting portion.
